(19) United States
(12) Patent Application Publication
(10) Pub. No.: US 2021/0354330 A1
(43) Pub. Date: Nov. 18, 2021

(54) ROTARY BLADE ASSEMBLY THAT CAN BE USED IN TILE-CUTTING MACHINES

(71) Applicant: GERMANS BOADA, S.A., Rubi (ES)

(72) Inventor: Salvador DURAN, Rubí (ES)

(21) Appl. No.: 17/281,959

(22) PCT Filed: Jan. 17, 2020
(86) PCT No.: PCT/ES2020/070030

§ 371 Date: Mar. 31, 2021

(30) Foreign Application Priority Data
Feb. 8, 2019 (ES) P201930098

(51) Int. Cl. B28D 1/24

(52) U.S. Cl. CPC B28D 1/24

(57) ABSTRACT

The invention relates to a rotary blade assembly that can be used in tile-cutting machines, which has an annular blade (1) mounted on a bearing (2) comprising an inner race (21), and outer race (22) and ball bearings (23). A first side of the outer race (22) comprises a perimeter projection (24) that forms a stop for mounting the blade (1) on the bearing. A securing ring (3) that forms a second stop for mounting the blade (1) is mounted and secured on the second side of the outer race (22), the bearing and/or the securing ring comprising projections or recesses (31, 25, 26) which are coupled to complementary recesses or projections (11, 12) defined in the blade and which prevent the relative rotation of the blade (1) with respect to the securing ring (3) and the outer race (22) of the bearing (2).

### TECHNICAL FIELD

This invention falls within the sector of tile-cutting machines, and more specifically in the manufacture of the rotary blade assembly, used in said cutting machines to mark a tear line on the tiles.

### BACKGROUND

Tile-cutting machines have a rotary blade mounted with the possibility of rotating on a shaft solidly attached with a securing rod to the cutting machine.

This blade has an annular configuration to enable the mounting thereof with the possibility of rotating on the shaft secured to the rod, either directly or with the interposition of a bearing that provides a smoother and more uniform movement of the blade.

The documents closest to the object of the present invention are those provided with a cutting assembly that can be used in tile-cutting machines, wherein the blade is mounted on a bearing.

Specifically, document U.S. Pat. No. 5,331,877A describes a rotary blade assembly used in a tile cutter that has inner and outer cylindrical tracks assembled in a single unit and between which ball bearings are arranged; the outer race having on the outer surface thereof a perimeter groove in which the annular blade is mounted.

In this document, the mounting of the assembly in the tile cutter is carried out by means of a securing shaft that is inserted in the central bore of the inner race of the bearing.

The problem posed by this background document is that mounting the annular blade in the perimeter groove of the outer race of the bearing requires subjecting the blade, made of a hard material, to significant stresses, which can cause breakage or detachment of portions of the material while using the cutter.

Moreover, this mounting requires obtaining a degree of adjustment between the blade and the outer race of the bearing so that both parts are solidly attached during rotation, which further complicates the mounting of the blade in the groove of the outer race of the bearing.

Document US20022189421 describes a rotary blade assembly used in a tile cutter comprising: a bearing provided with an outer race and an inner race between which ball bearings are arranged; and—a circular blade, of annular configuration, which is mounted in a centred position with respect to the outer race of the bearing and is secured by means of two securing rings, one arranged on each side of the blade. These securing rings are provided with a conical central bore, with tapering cross section towards the corresponding outer side, for the snap-fit thereof on the outer surface of the outer race of the bearing.

These securing rings act on the opposite sides of the blade and are held in the mounting position by the action of the ridge corresponding to the smaller base of the conical central bore against the surface of the outer race of the bearing.

This assembly does not guarantee that the securing rings are permanently kept in the initial mounting position, a slight misalignment of the tightening established by said securing rings against the opposite faces of the circular blade being sufficient for said blade not to rotate in a controlled and uniform manner with the outer race of the bearing, which can cause irregularities in the tear line marked by said blade on the tiles.

In some cases, the technical problem that arises is to prevent the hard metal of the blade from rotating on the outer race of the bushing and to provide an alternative solution that enables the blade to be mounted without stress to avoid risks of breakage.

The risks of breakage only occur in hard metal, since the stresses generated during the mounting of the bearing and the blade can cause this effect on hard metal.

Another known technique for securing the blade to the bearing consists of the use of adhesives; however, this solution does not guarantee a stable securing over time and requires spending excessive time in the manufacture of the rotary blade assembly with the bearing.

### SUMMARY

The rotary blade assembly that can be used in tile-cutting machines, object of this invention, is of the type mentioned above, that is, it has an annular blade mounted on a bearing comprising: a lower race, an outer race and ball bearings arranged between both races; this assembly being mounted by means of the inner race of the bearing on a shaft secured to a rod for connecting with the tile-cutting machine.

This blade cutting assembly has technical features aimed at guaranteeing the mounting of the blade on the outer surface of the outer race of the bearing without stresses that could damage the material thereof, and at guaranteeing the solidly attached rotation of the blade with the outer race of the bearing, preventing the blade from rotating with respect to said outer race of the bearing.

To achieve the proposed objectives, the outer race of the bearing comprises an outer surface, in contact with the blade, which has on a first side of the outer surface thereof a perimeter projection that forms a first side stop for mounting the blade on the bearing.

The cutting assembly further comprises a securing ring of the blade, which is mounted on a second side of the outer race of the bearing, secured to said outer race and that forms a second stop for mounting the blade; such that said blade is arranged between the perimeter projection that forms the first stop and the securing ring that forms the second stop.

An essential feature of the invention is that the bearing and/or the securing ring comprise on a contact surface with the blade projections or recesses, which in the mounting position of the assembly are coupled to complementary recesses or projections defined in the corresponding contact surface of the blade and prevent the relative rotation of the blade with respect to the securing ring and the outer race of the bearing.

With the aforementioned features, mounting the blade on the bearing does not require subjecting any of these elements to stresses that could affect the mounting or even cause some breakage of the material, the coupling of the complementary projections and recesses mentioned above being in charge of solidly attaching the rotation of the blade with the rotation of the outer race of the bearing and the securing ring.

Preferably, the securing ring and the outer race of the bearing are secured to each other by means of welding, micro-welding or interference, which is a quick solution and ensures that the securing ring cannot move or generate play in the side contact areas with the annular and radial contact blade with the outer race of the bearing.

According to the invention, the perimeter projection of the outer surface of the outer race of the bearing and the securing ring has thicknesses suitable for the centred arrangement of the blade with respect to the bearing.

The features of the invention and the different positions of the projections and of the recesses in charge of preventing the rotation of the blade with respect to the outer race of the bearing will be more easily understood in view of the exemplary embodiments shown in the figures.

### BRIEF DESCRIPTION OF THE DRAWINGS

As a complement to the description provided herein, and for the purpose of helping to make the features of the invention more readily understandable, the present specification is accompanied by a set of drawings which, by way of illustration and not limitation, represent the following:

FIG. 1 shows a schematic elevation view of a first exemplary embodiment of the rotary blade assembly that can be used in tile-cutting machines, according to the invention, mounted by means of a shaft on a rod for coupling to a tile-cutting machine.

FIG. 2 shows a cross section elevation view of the blade assembly of FIG. 1 along a vertical plane.

FIG. 3 shows a perspective view of the blade assembly of FIG. 1 seen from the side carrying weldings, micro-weldings or interferences between the securing ring and the outer race of the bearing.

FIG. 4 shows an exploded perspective view of the blade assembly of FIG. 1.

FIGS. 5 and 6 show respective elevation views of a variant embodiment of the blade assembly, exploded and mounted respectively, in which the blade and the securing ring have been cross-sectioned along a vertical plane.

FIG. 7 shows an exploded perspective view of a variant embodiment of the blade assembly in which the projections and recesses in charge of preventing the relative rotation of the blade with respect to the outer side of the bearing define on the inner surface of the blade and on the surface of the outer race of the bearing respective geometric, complementary and non-cylindrical shapes, in this case, quadrangular shapes.

FIG. 8 shows an elevation view of the blade assembly of FIG. 7, mounted, and with the blade and the securing ring cross-sectioned along a vertical plane.

### DETAILED DESCRIPTION

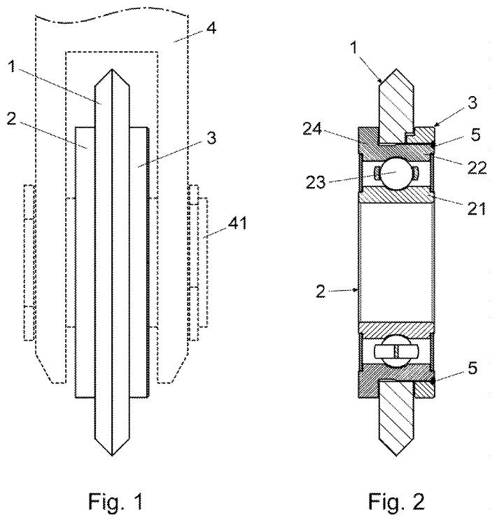

In the exemplary embodiment shown in FIGS. 1 to 4, the rotary blade assembly that can be used in tile-cutting machines comprises an annular blade (1) mounted on a bearing (2) which, as represented in FIG. 1, enables the rotation thereof with respect to a shaft (4) solidly attached to a rod (4) for securing said assembly to a tile-cutting machine (not shown).

In FIG. 2, the bearing (2) comprises: an inner race (21) with an axial bore for mounting thereof on the shaft (41), an outer race (22) and ball bearings (23) arranged between the inner race (21) and the outer race (22).

The outer race (22) of the bearing has a cylindrical outer surface provided on a first side with a perimeter projection (24), in a radial direction, that forms a first side stop for mounting the blade (1) on the part.

The securing of the blade (1) in the mounting position represented in FIG. 2 is carried out by means of a securing ring (3) mounted on a second side of the outer race (22) of the bearing (2) such that in the mounting position, the blade (1) is arranged between the perimeter projection (24) and the securing ring (3). The perimeter projection (24) of the outer race of the bearing and the securing ring (3) are dimensioned so that in the mounting position, the blade (1) is centred with respect to the median plane of the bearing (2).

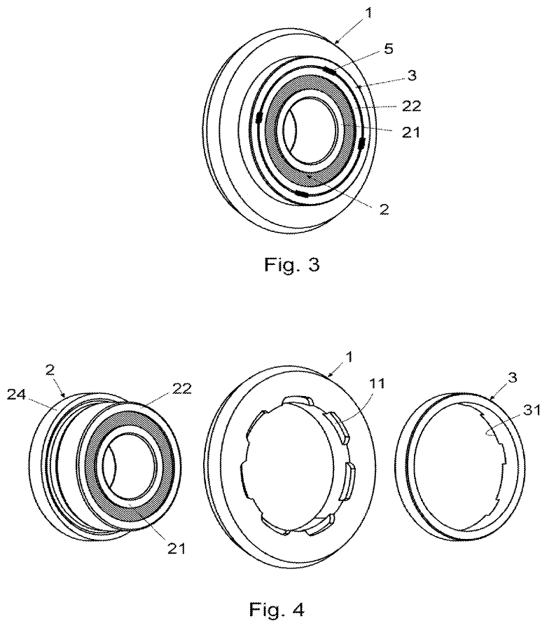

As shown in FIG. 3, the securing ring (3) is secured to the outer race (22) of the bearing by means of welding, micro-welding or interference (5) that prevent the relative movement thereof.

As can be seen in FIGS. 2 and 4, the blade (1) and the securing ring (3) have complementary projections (31) and recesses (11) on the facing side surfaces thereof, which are coupled to each other in the mounting position, such that the blade (1) rotates solidly attached with the securing ring (3) and consequently with the outer race (22) of the bearing that is secured to said securing ring (3) by means of welding, micro-welding or interference (5).

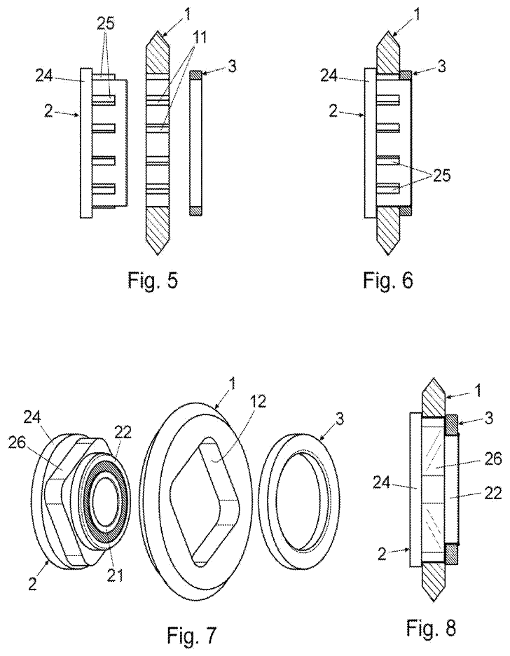

In the variant embodiment shown in FIGS. 5 and 6, the side projections (25) intended to be housed in the recesses (11) of the blade (1) are defined on the side of the outer race (22) of the bearing corresponding to the perimeter projection (24).

It should be mentioned that the recesses (11) defined in the cutting disc (1) may have a depth less than the width of the blade (1), as shown in FIGS. 2 and 4; or be through recesses, with a depth equal to the total width of the blade (1), as shown in FIG. 5.

In the variant embodiment shown in FIGS. 7 and 8, the complementary projections and recesses in charge of preventing the relative rotation of the blade (1) with respect to the outer race (22) of the bearing (2) are located on the surfaces of the blade and of the outer race that are faced in a radial direction; defining complementary non-cylindrical shapes (26, 12), in this specific case, quadrangular shapes.

Having sufficiently described the nature of the invention, in addition to a preferred exemplary embodiment, it is hereby stated for the relevant purposes that the materials, shape, size and layout of the described elements may be modified, provided that it does not imply altering the essential features of the invention claimed below.

1. A rotary blade assembly for use in tile-cutting machines, having an annular blade (1) mounted on a bearing (2) comprising an inner race (21), and outer race (22) and ball bearings (23) arranged between both races, a first side of the outer race (22) comprising a perimeter projection (24) that forms a first side stop for mounting the annular blade (1) on the bearing, the rotary blade assembly comprising:
a securing ring (3) of the annular blade (1) mounted on a second side of the outer race (22) of the bearing, secured to said outer race (22) and that forms a second stop for mounting the annular blade (1);
wherein the bearing and/or the securing ring comprise on a contact surface with the annular blade projections or recesses (31, 25, 26) which, in a mounting position of the assembly, are coupled to complementary recesses or projections (11, 12) defined in a corresponding contact surface of the annular blade, and prevent relative rotation of the annular blade (1) with respect to the securing ring (3) and the outer race (22) of the bearing (2).

2. The rotary blade assembly, according to claim 1, wherein the securing ring (3) and the outer race (22) of the bearing (2) are secured to each other by means of welding, micro-welding or interference (5).

3. The rotary blade assembly, according to claim 1, wherein the perimeter projection (24) of the outer race (22) of the bearing and the securing ring have thicknesses suitable for a centered arrangement of the annular blade with respect to the bearing.

4. The rotary blade assembly, according to claim 1, wherein the coupling projections (31) and the recesses (11) are defined on opposing side faces of the securing ring (3) and of the annular blade (1).

5. The rotary blade assembly, according to claim 1, wherein the projections (25) configured to be housed in the recesses (11) of the annular blade (1) are defined on the side of the outer race (22) of the bearing corresponding to the perimeter projection (24).

6. The rotary blade assembly, according to claim 1, wherein the recesses (11) defined in the annular blade (1) have a depth less than or equal to a total width of the annular blade (1).

7. The rotary blade assembly, according to claim 1, wherein the complementary projections and recesses in charge of preventing the relative rotation of the annular blade (1) with respect to the outer race (22) of the bearing (2) are arranged on surfaces that are faced in a radial direction of the annular blade (1) and of the outer race; defining complementary non-cylindrical shapes (26, 12).

8. The rotary blade assembly, according to claim 2, wherein the perimeter projection (24) of the outer race (22) of the bearing and the securing ring have thicknesses suitable for a centered arrangement of the annular blade with respect to the bearing.

9. The rotary blade assembly, according to claim 2, wherein the coupling projections (31) and the recesses (11) are defined on opposing side faces of the securing ring (3) and of the annular blade (1).

10. The rotary blade assembly, according to claim 3, wherein the coupling projections (31) and the recesses (11) are defined on opposing side faces of the securing ring (3) and of the annular blade (1).

11. The rotary blade assembly, according to claim 2, wherein the projections (25) configured to be housed in the recesses (11) of the annular blade (1) are defined on the side of the outer race (22) of the bearing corresponding to the perimeter projection (24).

12. The rotary blade assembly, according to claim 3, wherein the projections (25) configured to be housed in the recesses (11) of the annular blade (1) are defined on the side of the outer race (22) of the bearing corresponding to the perimeter projection (24).

13. The rotary blade assembly, according to claim 4, wherein the projections (25) configured to be housed in the recesses (11) of the annular blade (1) are defined on the side of the outer race (22) of the bearing corresponding to the perimeter projection (24).

14. The rotary blade assembly, according to claim 2, wherein the recesses (11) defined in the annular blade (1) have a depth less than or equal to a total width of the annular blade (1).

15. The rotary blade assembly, according to claim 3, wherein the recesses (11) defined in the annular blade (1) have a depth less than or equal to a total width of the annular blade (1).

16. The rotary blade assembly, according to claim 4, wherein the recesses (11) defined in the annular blade (1) have a depth less than or equal to a total width of the annular blade (1).

17. The rotary blade assembly, according to claim 5, wherein the recesses (11) defined in the annular blade (1) have a depth less than or equal to a total width of the annular blade (1).

18. The rotary blade assembly, according to claim 2, wherein the complementary projections and recesses in charge of preventing the relative rotation of the annular blade (1) with respect to the outer race (22) of the bearing (2) are arranged on surfaces that are faced in a radial direction of the annular blade (1) and of the outer race; defining complementary non-cylindrical shapes (26, 12).

19. The rotary blade assembly, according to claim 3, wherein the complementary projections and recesses in charge of preventing the relative rotation of the annular blade (1) with respect to the outer race (22) of the bearing (2) are arranged on surfaces that are faced in a radial direction of the annular blade (1) and of the outer race; defining complementary non-cylindrical shapes (26, 12).
